(19) United States
(12) Patent Application Publication
(10) Pub. No.: US 2008/0001948 A1
(43) Pub. Date: Jan. 3, 2008

(54) METHOD AND APPARATUS FOR THE COLLABORATIVE KNOWLEDGE-BASED CREATION AND EXTENSION OF AN INFORMATION GRAPH

(76) Inventor: Martin Christian Hirsch, Marburg (DE)

Correspondence Address: 24IP LAW GROUP USA, PLLC, 12 E. LAKE DRIVE, ANNAPOLIS, MD, 21403, US

(21) Appl. No.: 11/427,888

(22) Filed: Jun. 30, 2006

(51) Int. Cl. G06T 11/20

(52) U.S. Cl. 345/440

(57) ABSTRACT

A method and apparatus for the collaborative knowledge-based creation and extension of an information graph are taught. The method comprises a first step of retrieving items of a given, human-made information graph in a database, a second step of retrieving relations between the given elements, not yet drawn in the information graph or of retrieving characteristics of the given elements, or of retrieving information about the given elements, a third step of attaching these new relations and/or retrieved elements to the given graph on a graphical device and a fourth step of manually adding these proposed items of information to the information graph. The items of information include elements of information and relations between the elements of information. The elements of information are displayed as nodes on the relation map and the relations as lines on the relation map. The apparatus for the display of information on a screen comprises a query processor for processing a query from a user, a query interpreter for interpreting the query from the user, an information acquirer for retrieving items of the information form a database, a graph calculator for calculating a relation map and a drawing processor for creating graphical elements representing at least some of the items of information and for accepting instructions from the user to create at least one further graphical element.

### CROSS-REFERENCE TO RELATED APPLICATIONS

None.

### STATEMENT REGARDING FEDERALLY SPONSORED RESEARCH OR DEVELOPMENT

None.

### BACKGROUND OF THE INVENTION

1. Field of the Invention

The present invention relates to apparatus and accompanying methods that help to intensify the interchange and linking of information between humans and machines, for example personal computers or robots.

2. Brief Description of the Related Art

A mind map (or mind-map) is a diagram used to represent words and ideas linked to and arranged around a key word or idea. The mind-map is used to generate, visualize, structure and classify thoughts and ideas, and can also be used as an aid in study, organization, problem solving, and decision making. The mind-map is an image-centered diagram that represents semantic or other connections between portions of information. The mind-map encourages a brainstorming approach to any given organizational task as it eliminates the hurdle of initially establishing an intrinsically appropriate or relevant conceptual framework within which to work.

The mind-map generally involves elements such as images, words, and lines. The elements are arranged intuitively according to the importance of the concepts and they are organized into groupings, branches, or areas.

The mind-map is created by humans and has been traditionally done by using pen and paper. However, software is now available which provides presents graphical tools for bringing the associations and information of the user into the computer and onto the screen. Companies such as Mindjet, San Francisco, Calif., produce such software.

A semantic network is often used as a form of knowledge representation. The semantic network is a directed graph consisting of vertices which represent concepts and edges which represent semantic relations between the concepts. The semantic network is used extensively to provide computer representations of the relationships between various concepts. In some senses, one can consider the mind map to be a very free form variant of a semantic network created by a human.

The Resource Description Framework (RDF) is a family of World Wide Web Consortium (W3C) specifications which is used as a general method of modelling knowledge, through a variety of syntax formats (XML and non-XML). The RDF metadata model is based upon the idea of making statements about resources in the form of a subject-predicate-object expression which is called a “triple” in RDF terminology. For example, one way to represent the fact “The sky has the color blue” in RDF would be to use a triple whose subject is “the sky,” whose predicate is “has the color”, and whose object is “blue.” Predicates in the RDF are traits or aspects about a resource and express a relationship between the subject and the object.

The RDF's simple data model and ability to model disparate, abstract concepts has led to increasing use in knowledge management applications.

The triples of the Resource Description Framework (RDF) of the semantic web are designed to allow a machine based drawing of information graphs. The focus of the triples is to allow the machine to make an automatic drawing of information graphs (i.e. graph generated by computer from data input by user). The triples cannot currently be used to analyse and modify an information-graph that the user has previously created or to add information items to an existing information graph. In short, the approach of the RDF is not as “intelligent co-worker” with analysing, association and drawing capabilities but as a passive tool to draw the information graphs.

### SUMMARY OF THE INVENTION

In view of the foregoing, there is therefore a need to enable the bringing or linking of information stored within a machine with information provided by humans.

There is furthermore a need to allow the addition of information items (nodes or connections or notes or retrieved documents) to an existing information graph.

These and other objects of the invention are met by a method and apparatus which allows humans and machines a collaborative, interactive and knowledge-based drawing of graphs. In this invention, the machine becomes a knowledge-based co-worker of the user. The machine can offer refinement of the information the user expresses in the graph. In the invention, the machine examines the information graph drawn by the user draws and supplements the information by adding or offering or modifying elements or by assigning notes to existing elements or retrieving assets and information relating to the graph or to parts of the graph or to elements of the graph the user has activated. The machine learns from the information graph by integrating the new elements and the new relations provided by the user into its own knowledge base (relation network).

In a preferred embodiment, the invention is a method and apparatus for the collaborative knowledge-based creation and extension of an information graph. The method comprises a first step of retrieving items of a given, human-made information graph in a database, a second step of retrieving relations between the given elements, not yet drawn in the information graph or of retrieving characteristics of the given elements, or of retrieving information about the given elements, a third step of attaching these new relations and/or retrieved elements to the given graph on a graphical device and a fourth step of manually adding these proposed items of information to the information graph. The items of information include elements of information and relations between the elements of information. The elements of information are displayed as nodes on the relation map and the relations as lines on the relation map.

The apparatus for the display of information on a screen comprises a query processor for processing a query from a user, a query interpreter for interpreting the query from the user, an information acquirer for retrieving items of the information form a database, a graph calculator for calculating a relation map and a drawing processor for creating graphical elements representing at least some of the items of information and for accepting instructions from the user to create at least one further graphical element.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRITION OF THE DRAWINGS

For a more complete understanding of the present invention and the advantages thereof, reference is now made to the following description and the accompanying drawings, in which:

FIG. 1 is a block diagram depicting methods in accordance with preferred embodiments of the invention.

FIG. 2 depicts seven ways of how the methods can modify an information graph.

FIG. 3 depicts the idea of organizing information graphs in a kind of book (Multilayer Information Graph).

### DETAILED DESCRIPTION OF THE PREFERRED EMBODIMENTS

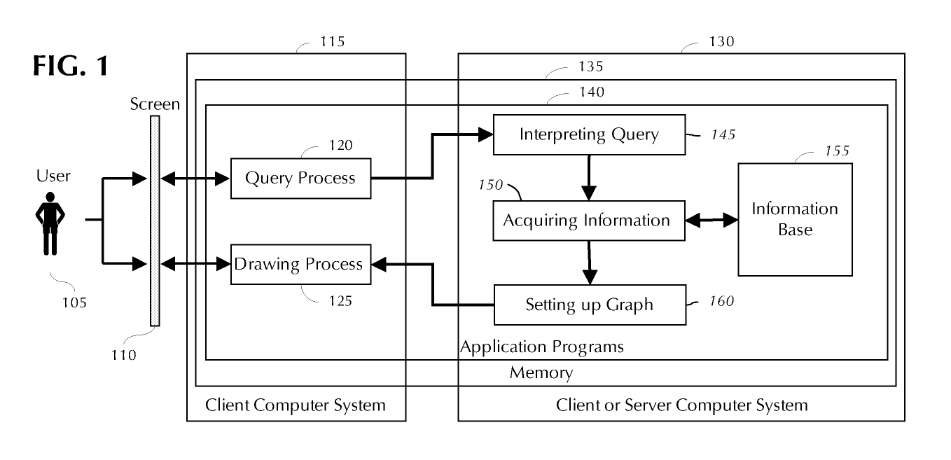

FIG. 1 illustrates one method of the invention. A user 105 interacts with a computer screen 110 or a similar input device, such as a graphic tablet. The computer screen 110 is attached to a client computer system 115 which is attached in turn to a server computer system 130. The server computer system 130 could also be incorporated into the client computer system 115.

There are two modes of operation of the client computer system 115: a query process 120 and a drawing process 125. The drawing process 125 operates by using the client computer system 115 as a graphic tool to draw an information graph representing a semantic network. This is done with the help of common graphic tools 125. These include, but are not limited to, graphic programmes such as Visio or ConceptDraw and the tools such as MindJet and MindManager mentioned above. The information graph can contain vertices, nodes, edges, text boxes, links, etc.

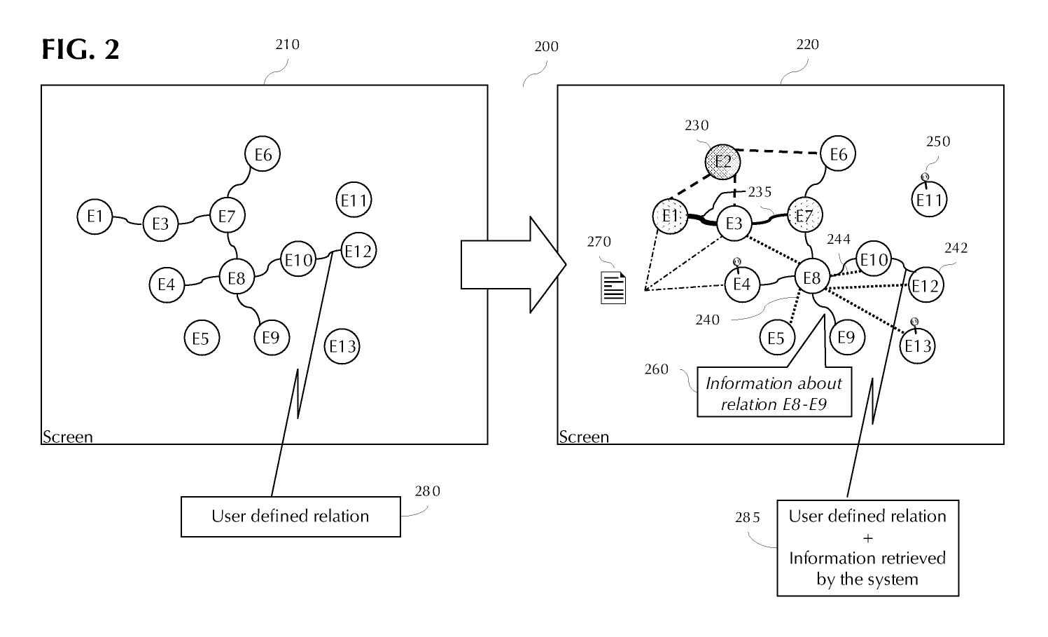

The second mode of operation is the query processor 120 in which the user 105 asks the client computer system 115 to perform knowledge-based operations 200 as will be explained in connection with FIG. 2. In this second mode of operation, the user 105 does not draw an information graph on the computer screen 110 but inputs a text-based query into the client computer screen 115 by means, for example, of a keyboard. Alternative methods of entry such as selection from drop-down lists are possible.

After the user 105 has entered the query, it is interpreted by a query interpreter 145. The query interpreter 145 analyses the kind of task which the user 105 is requesting. The query analyser 145 also sees whether an information graph has been previously generated and determines the actual status of the information graph (described below). Finally the query server 145 needs to acquire requested information.

The query server 145 uses an information acquirer 150 to acquire the information for the information graph. The information acquirer 150 has to communicate with an information base 155. The information base 155 may be a database or an association processor and will include a semantic network. The information may be stored in the information base 155 as an RDF triple or in another format, such an extended RDF format. If an information graph exists in the information base 155, then the current status of the information graph is transformed to a context. The context is generated by analysing the information attached to the nodes of the information graph and the edges between the nodes of the information graph. This is discussed in more details in the Applicant's co-pending U.S. patent application Ser. No. 11/350,095. The information acquirer 150 takes the context into account when acquiring the information. The information acquirer 150 will return a number of hits.

An example of this could be, for example, a request to drawn a view of the information graph related to Parkinson's disease. The information acquirer 150 would access the information base to determine what information is contained on Parkinson's disease and also whether the information graph had previously been requested (and was therefore stored). The hits relating to Parkinson's disease will be returned to the information acquirer 150.

Should an existing information graph be found in the information base 155, the existing information graph will be updated. This will occur, for example, in the event that new or additional information has been added to the information base 155 since the creation of the existing information graph. The existing information graph and the hits representing the new information are passed to a graph calculator 160. The graph calculator 160 produces a set of graphical instructions which are delivered to a drawing process 125 in the client computer system 115. The drawing process 125 creates graphical elements on the screen 110.

In the event that no existing information graph is found in the information base, the information acquirer retrieves the hits and passes the retrieved hits to the graph calculator 160. The graph calculator 160 calculates an initial information graph which is then sent to the drawing process 125 in the client computer 115 for creating graphical elements on the screen 110.

FIG. 2 illustrates the ways in which the machine supports the user 105 in creating the information graph. Suppose that the user 105 had created the information graph 210 as described above or has retrieved an existing information graph from the information base 155. The relation map 210 includes but is not limited to mind-maps and concept maps. The relation-map 210 has a plurality of elements E1-E13 as shown in the figure. Some of the elements E1-E13 are connected by edges or lines between other ones of the elements E1-E13. Each of the edges represents at least one relation between the connected ones of the elements E1-E13. So, for example, element E1 is connected by an edge to element E3 which is also connected by an edge to element E7. The element E7 is connected by edges to elements E3, E7 and E6. The relation map 210 is stored in a memory in the client computer system 115 and at least part of the relation map is displayed on the screen 110 using a graphics card. If the relation map 210 is so large, then only part of the relation map 210 is displayed on the screen 110 but the rest of the relation map is contained in graphic memory in the client computer and can be moved using known techniques (e.g. scrolling).

The edges on the relation map 210 are click-sensitive, i.e. clicking any area near one of the edges (or adjacent to one of the edges) selects the clicked one of the edges and will open a window with information 280 on the screen 110. The information 280 includes but is not limited to information about the relationship between the elements (in this case between E10 and E12) represented by the selected one of the edges.

As an example, the user 105 may be interested in the effects of dopamines on Parkinson's disease and clinical management. The relation map would include elements “Parkinson's disease”, “clinics” and “dopamine”. The user 105 would draw an edge between the element representing dopamines and the element representing Parkinsonian disease. Similar the user would draw a line between the element representing Parkinsonian disease and the element representing clinics. The user 105 may have heard that the presence of aluminium in the environment affects the susceptibility of a person to Parkinson's disease. The user 105 does not know the connection and therefore the element representing Aluminium is initially not connected to any of the other ones of the elements (such as element E13 in FIG. 2).

The user 105 can define whether the line (connection) be stored permanently within the information base 155. This can be done automatically by the system noticing the drawn line and storing the information but no further details. The system could also request from the user 105 details of the type of the link and the relationship between the nodes.

The user 105 having drawn the initial relation map 210 (using the drawing process 125) can then ask the server computer 130 to add further elements to the initial relation map 210. The user 105 can do this by activating, for example, elements E1, E3 and E6 requesting from the server computer system 130 their relation. This activation is done using the query process 120 in which the elements are selected and a query created which is sent to the query interpreter 145 as disclosed above. The query interpreter 145 accesses the information base 155 to find the hits relating to E1, E3 and E6.

In the case illustrated in FIG. 2b, the server computer system 130 identified a further relation between E1 and E6 via a new element E2 (i.e. a new hit in the information base 110). The server computer system 130 provides the new hit to the graph generator 160 which adds the new element E2 230 to the graph and draws the corresponding lines between E1 and E6 and E2 and E1 on the computer screen.

The user 105 can ask the graphic card in the client computer system 115 to color all of the elements belonging to a specific category. The user 105 can note that, for example, element E1 and E7 belongs to a first category and the element E2 to a second category.

The user 105 can ask the graphic card to code the empiric co-occurrence value between hits in the information base 155 by amending the thickness of the line between two of the elements E1-E13 representing this empiric co-occurrence value. This is shown as edge 235 in FIG. 2b.

The user can instruct the machine to add relations from E8 to any other element E1-E7, E9-E13 on the information graph 210. The graphic card system draws new edges, for example, to E5 240 but also to E3, E10, E12 and E13. Thereby the machine also moves the position of the elements 242 to optimize the graph. Should the machine find a relation other than the relation stated in the graph, the machine can add a relation between elements that had already been connected by the user. This is illustrated by new edge 244.

The user can ask the system to mark all of the elements E1-E13 that, for example are part of a structure not drawn in the graph. Then the system marks all these elements as is shown at 250 open the information graph 210.

The user 105 also allows annotation of the elements E1-E13 of the graph as is shown at 260. The annotations can be stored in the information base 155 and retrieved by the information acquirer when searching for hits. The annotations include information from another user about one of the relations, or information that is contradictory.

The user 105 can ask machine system to add documents (or links) to the information graph 210 as a whole or to parts of the information graph 210. The machine carries out the document and symbolizes the documents by an icon 270 at elements E1, E3 and E4. Double-clicking the icon 270 opens a list with documents related to the three elements E1, E3 and E4.

The user 105 can double-clicks an edge to see the relation specified by the edge and also the information retrieved by the machine (information, coupling-strength etc.).

The system draws every modification of the graph in a separate and transparent layer, like a transparent foil on top of a paper graph. The user 155 then selects those elements he wants to add to his graph in the transparent layer to create a transparent action-layer. The user can use a multiple of these transparent action-layers. The action-layers can be mapped onto each other to obtain the required result. This is similar to placing multiple transparent foils onto the paper graph to understand the relationships between the multiple transparent foils.

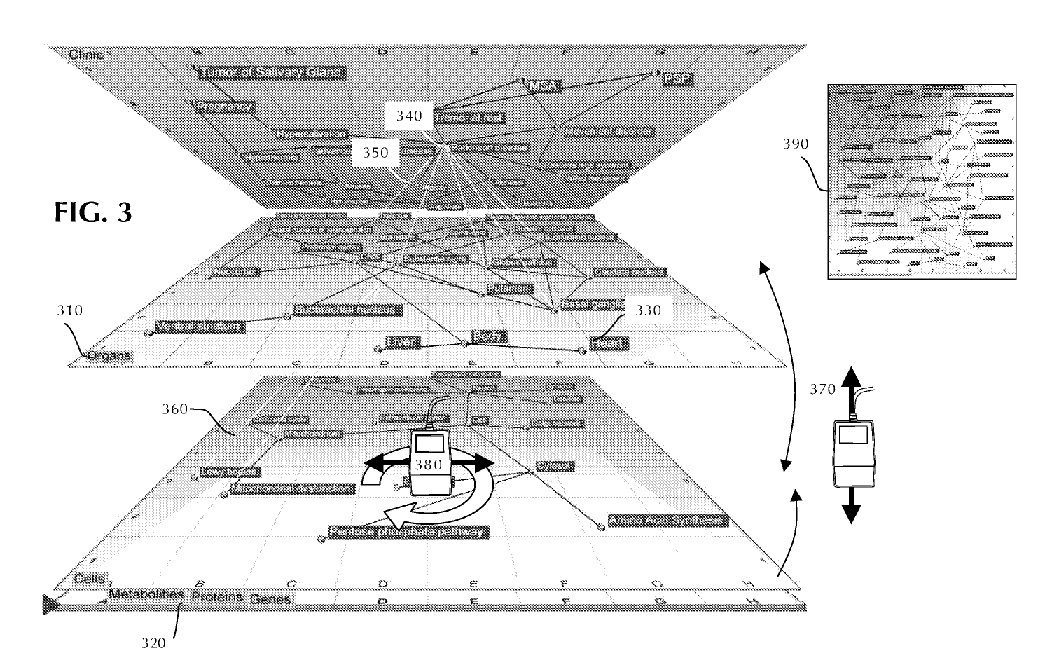

If the user has more than one information graph 210 it may be interesting to see relations between the more than one information graph 210. The user 105 can do this by bind the information graphs 210 together in a way such that the information graphs 210 can be handled like leafs in a book. This provides a layer of information graphs 210 called a Multilayer Information Graph as is shown in FIG. 3. Each one of the leaves has a tab-note with the name 310. Should the multilayer information graph be closed the tab-notes 310 allow fast access to the single leafs by clicking on one of them as is shown at 320.

Another way to move through the various leaves of the multilayer information graph would be to move the mouse up and down with mouse button down as is shown at 370. The information graph 210 is rotatable by moving the mouse sideward with mouse button depressed as is shown at 380. The content of each page can be seen from both sides of the leaf. Each node of the information graph 210 is provided with a label 330 which is presented to the user 105 on the computer screen. This occurs even during rotation of the information graph 210.

The user 105 can click on an element of the leaf in combination with a special modifier key and the machine will select lines 350 from the element to related elements on the subsequent leaf. This is shown as the adjacent leaf in FIG. 3 but could also be another leaf. This process can be “cascaded” using a cascading mechanism: in the first step lines are drawn to the elements on the adjacent leaf and in the second step lines are drawn from the elements in a further leaf. The user 105 will see a vertical network over all of the information graphs 210 presented in different leaves.

In the illustrated example the user 105 can at once see which elements on the leaf “cells” are connected to the starting element “Parkinson's Disease” and to which organ they belong (leaf “Organs”). The leaves are presented in a transparent manner and it is possible to look from top, so that all of the information graphs 210 can be seen as an overlay 390. Each one of the leaves can be blended in and out separately.

Although the present invention has been described in terms of a preferred embodiment, it is not intended that the invention be limited by this embodiment. Modifications within the spirit of the present invention will be apparent to those skilled in the art. The scope of the present invention is defined in the claims that follow.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A method for the display of information in a relation map comprising the steps of:
retrieving items of the information from a database, wherein the items of information include elements of information and relations between the elements of information;
creating the relation map from the items of information;
presenting at least part of the relation map on a graphical device, whereby the relations are displayed as lines between the elements are displayed as nodes on the graphical device; and
manually adding further items of information to the relation map.

2. A method according to claim 1, wherein the further items of information are stored in the database.

3. A method according to claim 1, wherein the further items of information include further relations between elements.

4. A method according to claim 1, wherein the further items of information include new elements.

5. A method according to claim 4, further comprising a step of retrieving further items of information from the database using the further elements.

6. A method according to claim 1, further comprising a step of coloring at least some of the elements to illustrate a common property of the at least some of the elements.

7. A method according to claim 1, further comprising a step of associating symbols to elements according to represent an information retrieval result.

8. A method according to claim 1, further comprising a step of reshaping the design of the relation map according to an information retrieval result.

9. A method according to claim 1, further comprising a step of attaching notes to elements of the relation map according to an information retrieval result.

10. A method according to claim 1, further comprising a step of drawing relations between manually added items of information, wherein the relations are established according to an information retrieval result.

11. A method according to claim 1, comprising a further step of accessing the database subsequent to the manual addition of further items of information to retrieve items of information relevant to the manually added further items of information.

12. A method according to claim 1, wherein the elements are located in a three dimensional space.

13. A method of claim 11, further comprising a step of placing all elements having a common property in one plane of the three dimensional space.

14. A method of claim 12, further comprising a step of drawing at least one line between at least one of the elements in a first plane and at least one of the elements in a second plane.

15. A method of claim 12 further comprising a step of selecting at least one element in a third plane and retrieving relations between the selected at least one element and further elements in other planes.

16. A method of claim 1, wherein the information represents a semantic network.

17. An apparatus for the display of information on a screen comprising:
a query processor for processing a query from a user;
a query interpreter for interpreting the query from the user;
an information acquirer for retrieving items of the information form a database, wherein the items of information include elements of information and relations between the elements of information;
a graph calculator for calculating a relation map; and
a drawing processor for creating graphical elements representing at least some of the items of information and for accepting instructions from the user to create at least one further graphical element.

18. An apparatus according to claim 17 wherein the query processor reviews the created further graphical elements and generates a relevant query to access further elements of information relevant to the at least one further graphical element.
